(19) United States
(12) Patent Application Publication
(10) Pub. No.: US 2013/0251426 A1
(43) Pub. Date: Sep. 26, 2013

(54) FIXING BELT, FIXING DEVICE, AND IMAGE-FORMING APPARATUS

(71) Applicant: Makoto OMATA, Kanagawa (JP)

(72) Inventor: Makoto OMATA, Kanagawa (JP)

(73) Assignee: FUJI XEROX CO., LTD., Tokyo (JP)

(21) Appl. No.: 13/614,892

(22) Filed: Sep. 13, 2012

(30) Foreign Application Priority Data
Mar. 23, 2012 (JP) 2012-068173

(51) Int. Cl. G03G 15/20

(52) U.S. Cl. 399/333

(57) ABSTRACT

A fixing belt includes a heat-insulating layer formed of a glass fiber or a porous ceramic and a metal heat-generating layer disposed outside the heat-insulating layer. The metal heat-generating layer generates heat by electromagnetic induction.

### CROSS-REFERENCE TO RELATED APPLICATIONS

This application is based on and claims priority under 35 USC 119 from Japanese Patent Application No. 2012-068173 filed Mar. 23, 2012.

### BACKGROUND

(i) Technical Field

The present invention relates to fixing belts, fixing devices, and image-forming apparatuses.

(ii) Related Art

Recently, fixing devices that heat a fixing belt by electromagnetic induction to perform fixing have been proposed for use with image-forming apparatuses.

### SUMMARY

According to an aspect of the invention, there is provided a fixing belt including a heat-insulating layer formed of a glass fiber or a porous ceramic and a metal heat-generating layer disposed outside the heat-insulating layer. The metal heat-generating layer generates heat by electromagnetic induction.

### BRIEF DESCRIPTION OF THE DRAWINGS

Exemplary embodiments of the present invention will be described in detail based on the following figures, wherein:

FIG. 1 is a schematic sectional view of a fixing belt according to an exemplary embodiment;

FIG. 2 is a schematic view of a fixing device according to an exemplary embodiment; and

FIG. 3 is a schematic view of an image-forming apparatus according to an exemplary embodiment.

### DETAILED DESCRIPTION

Exemplary embodiments of the present invention will now be described in detail.

### Fixing Belt

A fixing belt according to an exemplary embodiment includes a heat-insulating layer formed of a glass fiber or a porous ceramic and a metal heat-generating layer disposed outside the heat-insulating layer. The metal heat-generating layer generates heat by electromagnetic induction.

The fixing belt is used, for example, for a fixing device capable of electromagnetic induction heating in electrophotographic image-forming apparatuses. To deliver high fixing performance, the fixing belt needs to efficiently transfer heat generated from the metal heat-generating, layer by electromagnetic induction to a material to be fixed, such as a toner, on the outer surface of the fixing belt.

The fixing belt according to this exemplary embodiment includes a heat-insulating layer formed of a glass fiber or porous ceramic, which contains pores or voids, inside the metal heat-generating layer. The use of such a material may reduce the loss of the heat generated from the metal heat-generating layer through the inner surface of the fixing belt, thus allowing the heat to be efficiently transferred to the outside of the fixing belt. This may reduce power consumption and shorten heating time (warm-up time).

The glass fiber or porous ceramic also has pores or voids in the surface thereof. These pores or voids may produce an anchor effect to provide good adhesion to the layers adjacent to the heat-insulating layer. The layers adjacent to the heat-insulating layer are, for example, the metal heat-generating layer disposed outside the heat insulating layer and an optional substrate layer disposed inside the heat-insulating layer.

A fixing belt capable of electromagnetic induction heating contacts and heats a material (e.g., a toner) transferred to a recording medium such as paper to fix the material. The fixing belt requires sufficient flexibility to release the recording medium having the material fixed thereto. At the same time, the fixing belt requires sufficient rigidity not to be twisted or fractured during rotation.

Because the heat-insulating layer of the fixing belt according to this exemplary embodiment is formed of a glass fiber or porous ceramic, it may have a good balance of flexibility and rigidity as the layer formed inside the metal heat-generating layer. This may allow the fixing belt according to this exemplary embodiment to have sufficient flexibility to release a recording medium and sufficient rigidity not to be twisted.

### Thermal Conductivity

To more efficiently reduce the loss of the heat generated from the metal heat-generating layer through the inner surface of the fixing belt, the heat-insulating layer preferably has a thermal conductivity of 0.03 to 0.10 W/m-K or about 0.03 to about 0.10 W/m·K, more preferably 0.03 to 0.05 W/m·K or about 0.03 to about 0.05 W/m·K.

A thermal conductivity within the above upper limit may allow efficient reduction of the loss of heat through the inner surface of the fixing belt. A thermal conductivity within the above lower limit may provide the advantage of allowing the influence of temperature variations in the axial direction to be taken into account.

The thermal conductivity of the heat-insulating layer is measured as follows. The heat-insulating layer is cut into a 30 mm square film. The thermal conductivity of the film is measured using an ai-Phase Mobile thermal conductivity analyzer (from SII NanoTechnology Inc.).

The values disclosed herein are measured by the above procedure.

### Elastic Modulus

To ensure that the fixing belt, has sufficient flexibility to release a recording medium and sufficient rigidity not to be twisted, the heat-insulating layer preferably has an elastic modulus of 1.0 to 10.0 GPa or about 1.0 to about 10.0 GPa, more preferably 1.0 to 7.0 GPa or about 1.0 to about 7.0 GPa.

An elastic modulus within the above upper limit may provide moderate flexibility so that the fixing belt smoothly releases a recording medium. An elastic modulus within the above lower limit may provide moderate rigidity so that the fixing belt is not twisted.

The elastic modulus of the heat-insulating layer is measured as follows. The heat-insulating layer is cut into a 4 mm by 20 mm film. The elastic modulus of the film is measured using a RHEOVIBRON dynamic viscoelastometer (from A&D Company, Limited).

The values disclosed herein are measured by the above procedure.

### Structure of Fixing Belt

The structure of the fixing belt according to this exemplary embodiment will, now be described with reference to the drawings.

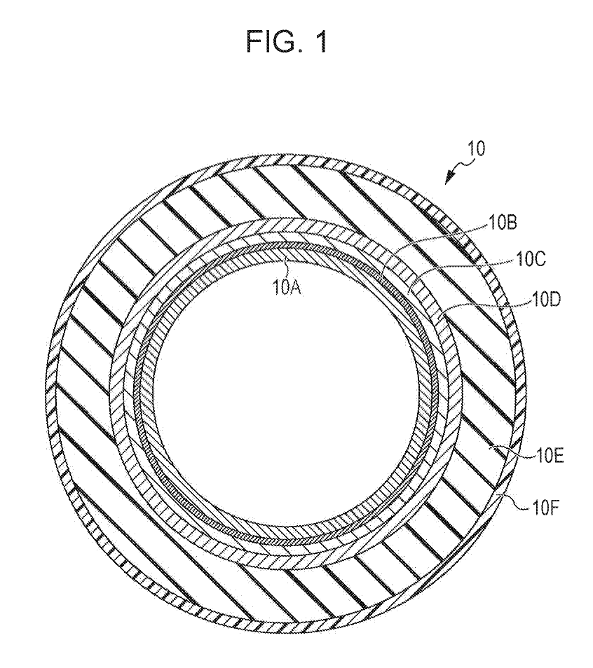

FIG. 1 is a schematic sectional view of the fixing belt according to this exemplary embodiment.

As shown in FIG. 1, a belt 10 according to this exemplary embodiment includes, in order from inside to outside, a heat-insulating layer 10A, a metal seed layer 10B, a metal heat-generating layer 10C, a metal protective layer 10D, an elastic layer 10E, and a release layer 10F.

Although the structure of the fixing belt 10 according to this exemplary embodiment is illustrated in FIG. 1, it may have any other structure including at least the heat insulating layer 10A and the metal heat-generating layer 10C. For example, the metal seed layer 10B, the metal protective layer 10D, the elastic layer 10E, and the release layer 10F may be omitted from the structure illustrated in FIG. 1. The fixing belt 10 may further include a substrate layer inside the heat-insulating layer 10A.

### Heat-Insulating Layer

The heat-insulating layer 10A may be any layer formed of a class fiber or porous ceramic. As used herein, the phrase “formed of a glass fiber or porous ceramic” does not necessarily mean that the heat-insulating layer 10A is formed only of a glass fiber or porous ceramic; it may contain other materials in such amounts that the effect thereof is not impaired.

As noted above, the heat-insulating layer 10A may have a thermal conductivity of 0.03 to 0.10 W/m·K or about 0.03 to about 0.10 W/m·K and an elastic modulus of 1.0 to 10.0 GPa or about 1.0 to about 10.0 GPa.

The glass fiber or ceramic contains pores or voids. The heat-insulating layer 10A preferably has a porosity of 80% or more, more preferably 90% or more.

A porosity within the above lower limit may provide the advantage of implementing effective heat insulation.

The porosity of the heat-insulating layer 10A may be derived from measurements of the density of the material (densitometer) and the basis weight and thickness of the heat-insulating layer 10A (weight meter, dial gauge, or scale). The values disclosed herein are obtained from material manufacturers.

The heat-insulating layer 10A preferably has a thickness of 20 to 180 μm, more preferably 20 to 80 μm.

A thickness within the above upper limit may contribute to low heat capacity, thus providing an energy-efficient fixing device. A thickness within the above lower limit may be effective for high paper release performance if the belt is bent during use.

The heat-insulating layer 10A is formed of, for example, glass fiber paper (glass paper) or porous ceramic paper.

The heat-insulating layer 10A may be formed of a commercial product. Examples of glass fiber paper include TGP (ultrathin glass paper; porosity: 85% or more; thickness: 20 μm) from Nippon Sheet Glass Co., Ltd. and AGM (ultrathin glass paper; porosity: 90% or more; thickness: 100 to 180 μm) from Nippon Sheet Glass Co., Ltd.

An example of porous ceramic paper is MARINETEX 02A (thickness: 180 μm) from Nichias Corporation.

Alternatively, a cylindrical glass fiber sheet or porous ceramic sheet may be used to form a seamless heat-insulating layer 10A.

A cylindrical, sheet may be formed in a known manner, for example, by forming a fibrous sheet on a cylindrical mold, or by weaving fibers into a cylindrical shape.

### Substrate Layer

The fixing belt 10 may further include a substrate layer inside the heat-insulating layer 10A for improved sliding across the inner surface of the fixing belt 10.

The substrate layer contains, for example, a resin as a major component. As used herein, the term “major component” means that the content thereof is 50% by mass or more, which applies hereinafter.

Examples of resins include polyimide, polyamideimide, fluorocarbon resins, aromatic polyamides, thermotropic liquid crystal polymers, polyester, polyethylene terephthalate, polyethersulfone, polyetherketone, and polysulfone, of which polyimide is preferred.

The resin used for the substrate layer may be for example, a foamed resin. The substrate layer may further contain a filler.

The substrate layer preferably has a thickness of 20 to 180 μm, more preferably 20 to 80 μm.

### Metal Seed Layer

If the metal heat-generating layer 105, described later, is formed by electroplating, the metal seed layer 10B may be provided as a basis for forming the metal heat-generating layer 105 by electroplating because it is difficult to directly perform electroplating on the heat-insulating layer 10A.

The metal seed layer 10B is formed of an electroless layer. Examples of electroless layers include electroless nickel layers, electroless copper layers, electroless tin layers, electroless gold layers, and electroless nickel-tantalum layers, of which electroless nickel layers are preferred.

The metal seed layer 10B has, for example, a thickness that does not impair the flexibility of the belt 10, for example, 0.1 to 10 μm.

### Metal Heat-Generating Layer

The metal heat-generating layer 10C functions to generate heat by, for example, inducing eddy currents in a magnetic field. The metal heat-generating layer 10C is formed of a metal capable of electromagnetic induction.

Examples of metals capable of electromagnetic induction include metals (e.g., nickel, iron, copper, gold, silver, aluminum, chromium, tin, and zinc) and alloys of two or more such metals (e.g., stainless steel).

In particular, suitable metals include copper, nickel, aluminum, iron, and chromium, and copper and copper-based alloys are preferred.

The metal heat-generating layer 10C may be formed in a known manner. For example, electroless plating may be performed on the heat-insulating layer 10A. Alternatively, as noted above, the metal seed layer 10B may be provided on the heat-insulating layer 10A before electroplating.

The appropriate thickness of the metal heat-generating layer 10C varies depending on the material used. For example, if copper is used, the metal heat-generating layer 10C preferably has a thickness of 3 to 50 μm, more preferably 5 to 20 μm.

### Metal Protective Layer

The metal protective layer 10D is disposed on the metal heat-generating layer 10C to prevent cracking of the metal heat-generating layer 10C after repeated deformation and to inhibit oxidative degradation after repeated heating for an extended period of time, thereby maintaining its heat generation performance.

The metal protective layer 10D may be optionally provided.

The metal protective layer 10D may be formed of, for example, an oxidation-resistant metal layer having high durability and oxidation resistance. For example, the metal protective layer 10D may be formed of an electroplated layer for ease of processing as a thin film. In particular, the metal protective layer 10D may be formed of an electroplated nickel layer, which has high strength.

The appropriate thickness of the metal protective layer 10D varies depending on the material used. For example, it nickel is used, the metal protective layer 10D may have a thickness of 2 to 20 μm.

### Elastic Layer

The elastic layer 10E conforms to irregularities of a toner image on a recording medium so that the surface of the fixing belt 10 comes into intimate contact with the toner image.

The elastic layer 10E may be formed of a material that returns to its original shape after being deformed under a pressure of, for example, 100 Pa, Known elastic materials may be used, including heat-resistant rubbers such as silicone rubbers and fluorocarbon rubbers. Examples of such materials include SE6744 liquid, silicone rubber from Dow Corning Toray Co., Ltd. and Viton B-202 from DuPont Dow Elastomers LLC.

The elastic layer 101 preferably has a thickness of, for example, 0.1 to 3 mm, more preferably 0.15 to 1 mm.

### Release Layer

If the fixing belt 10 as used as a heat-fixing belt to melt and fix an unfixed toner image to a recording medium, the release layer 10F prevents the molten toner from adhering to the fixing belt 10. The release layer 10F may be optionally provided.

The release layer 10F may contain, for example, a fluorinated compound as a major component. Examples of fluorinated compounds include fluorocarbon resins such as fluorocarbon rubbers, polytetrafluoroethylene (PTEE), perfluoroalkyl-vinyl ether copolymer (PFA), and ethylene tetrafluoride-propylene hexafluoride copolymer (FEP).

The release layer 10F preferably has a thickness of, for example, 1 to 100 μm, more preferably 10 to 50 μm.

### Thickness Measurement.

The thicknesses of the individual, layers are measured as follows. The thicknesses of the heat-insulating layer 10A, the elastic layer 10E, and the release layer 10F are measured using an eddy-current thickness gauge (available from Fischer Instruments K.K.). The thicknesses of the metal seed layer 10B, the metal heat-generating layer 10C, and the metal protective layer 10D are measured using an X-ray fluorescence thickness gauge (available from Fischer instruments K.K.),

### Manufacture of Fixing Belt

An example of a method for manufacturing a fixing belt 10 will now be described. The method described herein forms a fixing belt including a heat-insulating layer; a metal heat-generating layer, a metal protective layer, an elastic layer, and a release layer outside the heat-insulating layer; and a substrate layer inside the heat-insulating layer.

The method begins with providing a heat-insulating layer such as glass fiber paper. The heat-insulating layer is wound around a core for manufacture of a fixing belt. The heat-insulating layer wound around the core is subjected to electroless plating to form a metal heat-generating layer (e.g., a 15 μm thick copper layer) and then to electroplating to form a metal protective layer (e.g., a 5 μm thick nickel layer).

An elastic material such as liquid silicone rubber is applied to the metal protective layer by dipping and is cured by baking to form an elastic layer.

An adhesive is applied to the elastic layer. The core coated with the adhesive is inserted into and covered with a release layer tube such as a PFA tube, with its hoe expanded. The tube is baked and is cut to remove unnecessary portions, thus forming a release layer.

A material for forming a substrate layer is applied to the inner surface of the heat-insulating layer and is baked to form a substrate layer (e.g., a polyimide layer) on the inner surface. Thus, a fixing belt is obtained.

### Fixing Device

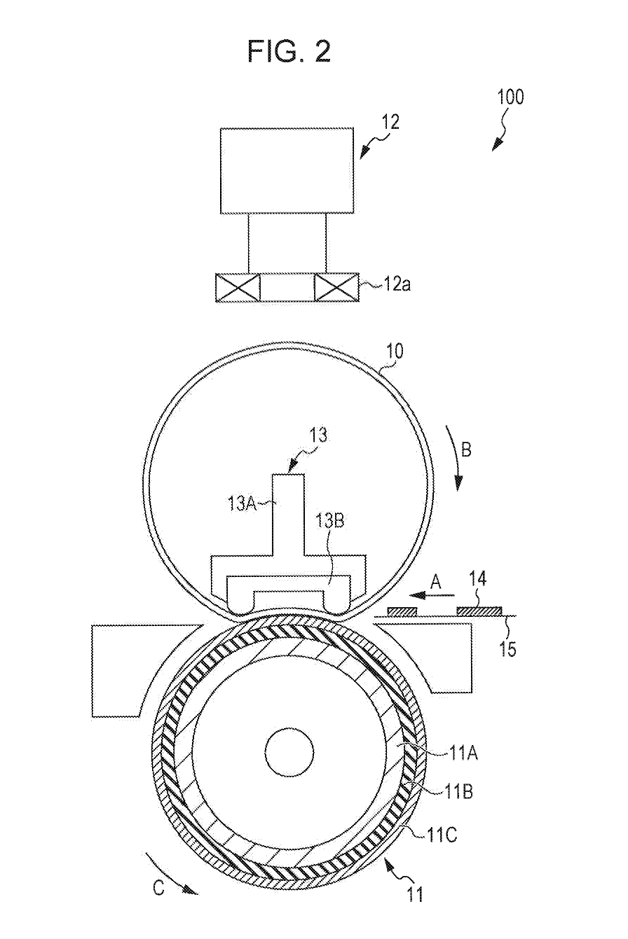

FIG. 2 is a schematic view of a fixing device according to an exemplary embodiment.

A fixing device 100 according to this exemplary embodiment is, for example, an electromagnetic induction fixing device including the fixing belt 10 according to the above exemplary embodiment. As shown in FIG. 2, the fixing device 100 includes a pressing roller (pressing member) 11 that presses a portion of the fixing belt 10. For efficient fixing, the pressing roller 11 forms a contact region (nip) with the fixing belt 10, which is curved along the circumferential surface of the pressing roller 11. For sufficient releasability of a recording medium, the fixing belt 10 has bends at the ends of the contact region (nip).

The pressing roller 11 includes a substrate layer 11A, an elastomeric layer 11B disposed on the substrate layer 11A, and a release layer 11C disposed on the elastomeric layer 11B. The elastomeric layer 11B is formed of, for example, silicone rubber. The release layer 10F is formed of, for example, a fluorinated compound.

The fixing device 100 further includes a counter member 13 disposed opposite the pressing roller 11 inside the fixing belt 10. The counter member 13 is formed of, for example, a metal, heat-resistant resin, or heat-resistant rubber. The counter member 13 includes a support 13A and a pad 13B supported by the support 13A. The pad 13B contacts the inner surface of the fixing belt 10 to locally apply more pressure.

The fixing device 100 further includes an electromagnetic induction heating device 12 that incorporates an electromagnetic induction coil (exciting coil) 12a disposed opposite the pressing roller 11 (an example of a pressing member) with the fixing belt 10 therebetween. The electromagnetic induction heating device 12 supplies an alternating current to the electromagnetic induction coil 12a to generate a magnetic field. The exciting circuit varies the magnetic field to induce eddy currents in the metal heat-generating layer 10C of the fixing belt 10. These eddy currents are converted to heat (Joule heat) by the electrical resistance of the metal heat-generating layer 10C, thus heating the surface of the fixing belt 10.

The electromagnetic induction heating device 12 is not necessarily disposed at the position shown in FIG. 2. For example, the electromagnetic induction heating device 12 may be disposed upstream of the contact region of the fixing belt 10 in a rotational direction B, or may be disposed inside the fixing belt 10.

In the fixing device 100 according to this exemplary embodiment, the fixing belt 10 is rotated in the direction indicated by the arrow B as driving force is transmitted to gears disposed at both ends of the fixing belt 10 by a drive unit (not shown). As the fixing belt 10 is rotated, the pressing roller 11 is rotated in the opposite direction, i.e., in the direction indicated by the arrow C.

A recording medium having an unfixed toner image 14 formed thereon is passed through the contact region (nip) between the fixing belt 10 and pressing roller 11 of the fixing device 100 in the direction indicated by the arrow A. The unfixed toner image 14 is melted and fixed to the recording medium 15 under pressure.

### Image-Forming Apparatus

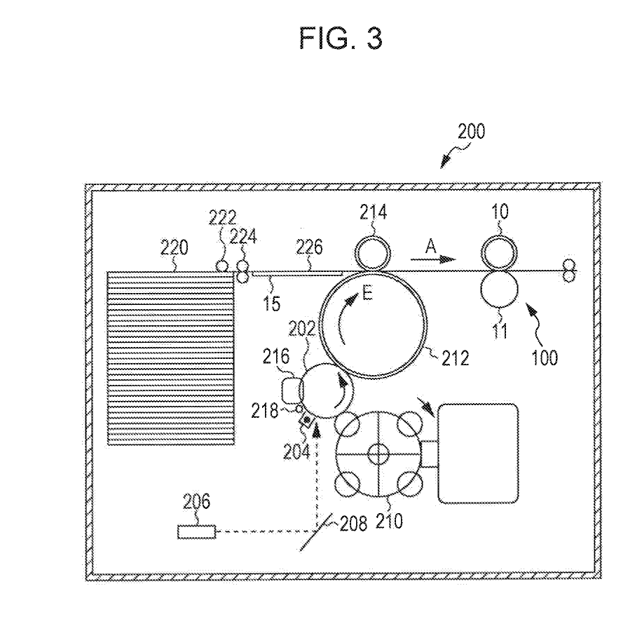

FIG. 3 is a schematic view of an image-forming apparatus according to an exemplary embodiment.

As shown in FIG. 3, an image-forming apparatus 200 according to this exemplary embodiment includes a photoreceptor (an example of an image carrier) 202, a charging device 204, a laser exposure device (an example of a latent-image forming device) 206, a mirror 208, a developing device 210, an intermediate transfer member 212, a transfer roller (an example of a transfer device) 214, a cleaning device 216, an erasing device 218, the fixing device 100, and a paper feed device. The paper feed device includes a paper feed unit 220, a paper feed roller 222, a registration roller 224, and a recording medium guide 226.

The image-forming operation of the image-forming apparatus 200 begins when the charging device 204, which is disposed in proximity to the photoreceptor 202, charges the surface of the photoreceptor 202 by non-contact charging.

The laser exposure device 208 emits a laser beam based on image information (signal) for each color. The mirror 208 directs the laser beam onto the surface of the photoreceptor 202 charged by the charging device 204 to form an electrostatic latent image.

The developing device 210 applies toners to the latent image formed on the surface of the photoreceptor 202 to form toner images. The developing device 210 includes developing units (not shown), each containing cyan, magenta, yellow, or black toner. As the developing device 210 is rotated in the direction indicated by the arrow, the developing device 210 applies the toners to the latent image formed on the surface of the photoreceptor 202 to form toner images.

The toner images formed on the surface of the photoreceptor 202 are transferred to the outer surface of the intermediate transfer member 212 at the contact between the photoreceptor 202 and the intermediate transfer member 212 by a bias voltage applied thereacross. The toner images are superimposed on top of each other such that they match the image information for the respective colors.

The intermediate transfer member 212 is rotated in the direction indicated by the arrow E, with the outer surface thereof in contact with the surface of the photoreceptor 202.

In addition to the photoreceptor 202, the transfer roller 214 is disposed around the intermediate transfer member 212.

The intermediate transfer member 212 having the color toner image transferred thereto is rotated in the direction indicated by the arrow E. The toner image is transferred from the intermediate transfer member 212 to the surface of the recording medium 15 at the contact between the transfer roller 214 and the intermediate transfer member 212. The recording medium 15 is fed to the contact in the direction indicated by the arrow A by the paper feed device.

The recording medium 15 is fed to the contact between the intermediate transfer member 212 and the transfer roller 214 as follows. The recording medium 15 contained in the paper feed unit 220 is lifted by a recording-medium lifting member (not shown) built into the paper feed unit 220 until the recording medium 15 contacts the paper feed roller 222. When the recording medium 15 contacts the paper feed roller 222, the paper feed roller 222 and the registration roller 224 are rotated to transport the recording medium 15 along the recording medium guide 226 in the direction indicated by the arrow A.

The toner image 14 transferred to the surface of the recording medium 15 is moved in the direction indicated by the arrow A. Upon reaching the contact region (nib) between the fixing belt 10 and the pressing roller 11, the toner image 14 is fixed to the surface of the recording medium 15 as it is melted and pressed against the recording medium 15. Thus, a fixed image is formed on the surface of the recording medium 15.

After the toner image is transferred to the surface of the intermediate transfer member 212, the cleaning device 216 cleans the surface of the photoreceptor 202.

After the cleaning device 216 cleans the surface of the photoreceptor 202, the erasing device 218 eliminates any charge therefrom.

### EXAMPLES

The present invention is further illustrated by the following non-limiting examples.

### Example 1

### Fabrication of Fixing Belt

Glass fiber paper (TGP from Nippon Sheet. Glass Co., Ltd.; porosity: 85% or more; thickness: 20 μm), which is to form a heat-insulating layer, is wound around a core for manufacture of a fixing belt and is fixed at both ends with heat-resistant tapes.

The glass fiber paper wound around the core is subjected to electroless plating to form a metal heat-generating layer (15 μm thick cooper layer) and then to electroplating to form a metal protective layer (5 μm thick nickel layer).

A liquid silicone rubber (liquid injection molding (LIM) material from Shin-Esu Chemical Co., Ltd.) is applied to the metal protective layer by dipping and is cured by baking at 120° C. for 10 minutes to form an elastic layer having a thickness of 200 μm.

A silane coupling adhesive (from Dow Corning Toray Silicone Co., Ltd.) is applied to the elastic layer and is dried at 150° C. for 10 minutes. The core having the outermost surface thereof coated with the adhesive is inserted into and covered with a PIA tube (30 μm thick; from Kurabo Industries Ltd.), with its hole expanded. The PFA tube is baked at 200° C. for four hours and is cut at both ends to remove unnecessary portions, thus forming a release layer.

Thus, a fixing belt is obtained.

### Example 2

A fixing belt including a seamless heat-insulating layer is fabricated by repeating the procedure of Example 1 except that the glass fiber paper (TOP from Nippon. Sheet Glass Co., Ltd.; porosity: 85% or more; thickness: 20 μm) is replaced by a cylindrical glass fiber sheet fabricated as follows.

The cylindrical glass fiber sheet is fabricated by forming a glass fiber sheet on a cylindrical mold and pressing the sheet into a cylindrical shape. The resulting belt has a thickness of 80 μm.

### Example 3

A fixing belt is fabricated, by applying an N-methylpyrrolidone solution of a polyamic acid (U Imide from Unitika Ltd.; concentration: 20% by mass)) to the inner surface of the fixing belt fabricated in Example 1 and baking the coating at 360° C. for one hour to form a substrate layer (10 μm thick polyimide layer) on the inner surface.

### Comparative Example 1

A fixing belt for comparison is fabricated by repeating the procedure of Example 1 except that, instead of forming the heat-insulating layer by winding the glass fiber paper around the core, a substrate layer is formed on the core. The metal heat-generating layer, the metal protective layer, the elastic layer, and the release layer are formed on the substrate layer by the procedure of Example 1. The substrate layer is formed as follows.

The substrate layer is formed by applying an N-methylpyrrolidone solution of a polyamic acid (U Imide from Unitika Ltd.; concentration: 20% by mass)) to the core and baking the coating at 360° C. for one hour to form a substrate layer (70 μm thick polyimide layer) on the core.

### EVALUATIONS

### Warm-Up Time

Each of the fixing belts fabricated in the Examples and Comparative Example is mounted as a fixing belt on a fixing device capable of electromagnetic induction heating in an electrophotographic image-forming apparatus (DocuCenter IV 2275 from Fuji Xerox Co, Ltd.) to measure the warm-up time thereof. The results are shown in Table 1.

The fixing belt of Example 1 has a 30% shorter warm-up time than the fixing belt of Comparative Example 1.

### Power Consumption

With the above electrophotographic image-forming apparatus, 22 copies are printed to measure the power consumed during the print test. The results are shown in Table 1.

TABLE 1

| | Warm-up time | Power consumption |
|---|---|---|
| | (s) | (Wh) |
| Example 1 | 4.2 | 606 |
| Example 2 | 5.6 | 960 |
| Example 3 | 5.0 | 815 |
| Comparative | 6.0 | 980 |
| Example 1 | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing belt comprising:
a heat-insulating layer comprising a glass fiber or a porous ceramic; and
a metal heat-generating layer disposed outside the heat-insulating layer, the metal heat-generating layer generating heat by electromagnetic induction.

2. The fixing belt according to claim 1, wherein the heat-insulating layer has a thermal conductivity of about 0.03 to about 0.1 W/m-K and an elastic modulus of about 1.0 to about 10.0 GPa.

3. A fixing device comprising:
the fixing belt according to claim 1;
a pressing member that presses an outer surface of the fixing belt, the pressing member and the fixing belt holding a recording medium having an unfixed toner image formed thereon; and
an electromagnetic induction heating device that causes the metal heat-generating layer of the fixing belt to generate heat by electromagnetic induction.

4. An image-forming apparatus comprising:
an image carrier having a surface;
a charging device that charges the surface of the image carrier;
a latent-image forming device that forms a latent image on the surface of the image carrier;
a developing device that develops the latent image with a toner to form a toner image;
a transfer device that transfers the toner image to a recording medium; and
the fixing device according to claim 3, the fixing device fixing the toner image to the recording medium.
